(19) United States
(12) Patent Application Publication
(10) Pub. No.: US 2021/0396351 A1
(43) Pub. Date: Dec. 23, 2021

(54) LOCKING SOLENOID BRACKET

(71) Applicant: John Hurban, Phoenix, AZ (US)

(72) Inventor: John Hurban, Phoenix, AZ (US)

(21) Appl. No.: 17/345,561

(22) Filed: Jun. 11, 2021

Related U.S. Application Data
(60) Provisional application No. 63/042,105, filed on Jun. 22, 2020.

(51) Int. Cl. F16M 13/02

(52) U.S. Cl. CPC F16M 13/02

(57) ABSTRACT

A bracket mounting device for protecting a solenoid. The mounting bracket device secures the solenoid in place. The bracket mounting device is configured to reinforce the linear plunger-type solenoid increasing stability and strength. The solenoid is encapsulated by the bracket mounting device. A solenoid case bracket that cover the solenoid extends from a pair of base flanges that are used to attach the bracket mounting device to the solenoid and a surface to which the solenoid is attached. A plurality of reinforcing elements provide additional strength to a connection between the solenoid case bracket and the pair of base flanges. The mounting bracket device protects the solenoid from external pressure damage and holds the solenoid in place.

### CROSS-REFERENCE TO RELATED APPLICATION

The present application claims priority to, and the benefit of, U.S. Provisional Application No. 63/042,105, which was filed on Jun. 22, 2020, and is incorporated herein by reference in its entirety.

### BACKGROUND

The present invention generally relates to a locking mount for a solenoid, and more specifically to a bracket mount device for a plunger type solenoid. Accordingly, the present specification makes specific reference thereto. However, it is to be appreciated that aspects of the present invention are also equally amenable to other like applications, devices and methods of manufacture.

A linear solenoid is an electromagnetic device that converts electrical energy into a mechanical pushing or pulling force or motion. These devices generally consist of an electrical coil wound around a cylindrical tube with a ferro-magnetic actuator or plunger that is free to move or slide in and out of the coil body. Solenoids are useful mechanisms that can be used to electrically open doors and latches, open or close valves, move and operate robotic limbs and mechanisms, and even actuate electrical switches just by energizing its coil.

Solenoids are available in a variety of formats with the more common types being the linear solenoid also known as the linear electromechanical actuator, (LEMA) and the rotary solenoid. Both types of solenoid, linear and rotational are available as either a holding (continuously energized) or as a latching type (ON-OFF pulse) with the latching types being used in either energized or power-off applications. Linear solenoids can also be designed for proportional motion control were the plunger position is proportional to the power input.

When electrical current flows through a conductor it generates a magnetic field. The direction of this magnetic field with regards to its north and south poles is determined by the direction of the current flow within the wire. The coil of wire becomes an electromagnet with its own north and south poles being exactly the same as that for a permanent magnet. The strength of this magnetic field can be increased or decreased by either controlling the amount of current flowing through the coil or by changing the number of turns or loops present in the coil.

When an electrical current is passed through the coil's windings, it behaves like an electromagnet. The plunger, which is located inside the coil, is attracted towards the center of the coil by the magnetic flux setup within the coil's body, which in turn compresses a small spring attached to one end of the plunger. The force and speed of the movement of the plunger is determined by the strength of the magnetic flux generated within the coil. When the supply current is turned off or is deenergized, the electromagnetic field generated previously by the coil collapses and the energy stored in the compressed spring forces the plunger back out to its original resting position. This back and forth movement of the plunger is known as the solenoid's “Stroke” which is the maximum distance the plunger can travel in and out.

This type of solenoid is generally called a linear solenoid because of the linear directional movement and action of the plunger. Linear solenoids are available in two basic configurations: a “Pull-type” that pulls the connected load towards itself when energized, and the “Push-type” that acts in the opposite direction by pushing it away from itself when energized. Both the push and pull types are generally constructed similarly with the difference being the location of the return spring and design of the plunger. Linear solenoids are useful in many applications that require an open or closed type motion, such as electronically activated door locks, pneumatic or hydraulic control valves, robotics, automotive engine management, irrigation valves, and the like. They are available as open frame, closed frame or sealed tubular types.

One problem with linear or plunger solenoids is that a locking solenoid will easily fail and separate if pressure is applied externally. A failed solenoid requires replacement as failure can cause a section of a machine using the solenoid to become inoperative. Solenoids are vulnerable to external and internal pressure. A solenoid can vibrate or hammer itself into pieces or can be subject to other external pressure. Additionally, excessive force can be caused internally by overvoltage or by a reduced load on the solenoid that must be absorbed when the plunger hits the C-stack or field.

In this manner, the improved bracket mount device of the present invention accomplishes all of the forgoing objectives, thereby providing an easy solution to protect linear plunger solenoids from damage. A primary feature of the present invention is an external protecting bracket that will not interfere with the normal solenoid mount. Finally, the improved of the present invention is capable of improving the lifespan of linear plunger solenoids by securing the solenoid in place while also encapsulating the solenoid for stability and strength while preventing the solenoid mechanism from failing due to pressure.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a bracket mounting device for protecting a solenoid. The solenoid is typically a linear plunger-type solenoid that is mountable on a surface. The bracket mounting device is integrally formed as a single unit. The bracket mounting device comprises a pair of base flanges and a solenoid case bracket. The pair of base flanges are wings that will cover a portion of a mounting plate of the solenoid. Each base flange comprises a securing hole. The securing holes are positioned so as to align with securing holes in the mounting plate of the solenoid.

The solenoid case bracket comprises a first sidewall and a second sidewall. The first sidewall extends substantially perpendicularly from one of the base flanges. The second sidewall extends substantially perpendicularly from the other base flange. The solenoid case bracket further comprises a top that connects the first and second sidewalls. The solenoid case bracket is open at the front, back, and bottom. The first sidewall comprises a channel formed into an inside surface of the first sidewall for accepting the electrical leads of the solenoid. The second sidewall and the top each comprise a cutaway portion. The cutaway portions of both the second sidewall and the top join where the second sidewall meets the top.

The mounting bracket device further comprises a plurality of stabilizing elements. The plurality of stabilizing elements are typically fins or ribs. The plurality of stabilizing elements are configured to reinforce the bracket mounting device between each of the pair of base flanges and the corresponding first or second sidewall that extends perpendicularly therefrom.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a bracket mount device of the present invention in accordance with the disclosed architecture.

FIG. 2 illustrates a side cut away view of a prior art linear plunger solenoid in accordance with the disclosed architecture.

FIG. 3 illustrates a front perspective view of the bracket mount device of the present invention encapsulating the linear plunger solenoid in accordance with the disclosed architecture.

FIG. 4 illustrates a rear perspective view of the bracket mount device of the present invention encapsulating the linear plunger solenoid in accordance with the disclosed architecture.

FIG. 5 illustrates a front perspective view of the bracket mount device of the present invention encapsulating the linear plunger solenoid in accordance with the disclosed architecture.

FIG. 6 illustrates an overhead perspective view of the bracket mount device of the present invention encapsulating the linear plunger solenoid while engaging a cam in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a bracket mount device. The bracket mount device is designed to hold a plunger solenoid in place. The bracket mount device encapsulates the solenoid and can prevent a cam from turning. The invention prevents the solenoid from failing by increasing the strength and stability of the encapsulated solenoid. The bracket mount device is cast as one fixture. The pre-existing mounting screws that hold the solenoid are used to also secure the bracket mount device over the solenoid. The bracket mount device secures the solenoid to prevent external pressure damage and device integrity.

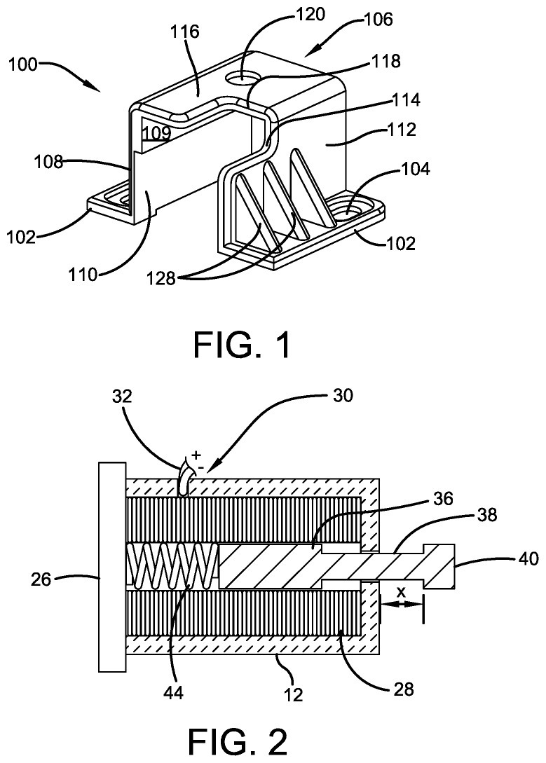

Referring initially to the drawings, FIG. 1 illustrates a bracket mount device 100. The bracket mount device 100 is configured to protect a solenoid 10. As illustrated in FIG. 2, a solenoid 10, such as a linear plunger-type or locking solenoid, comprises a case 12 secured to a mounting plate 26. The solenoid 10 further comprises a plunger 36 comprising a head 40 extending from a rod 40. The plunger 36 is movably situated in a bore 34 which is surrounded by a coil winding 28. When electrical current flows through the coil winding 28 it generates a magnetic field which, along with a return spring 44, moves the plunger 36 back and forth along a stroke distance (x). A pair of electrical leads 32 provide the current to the solenoid 10 via an electrical connection 30.

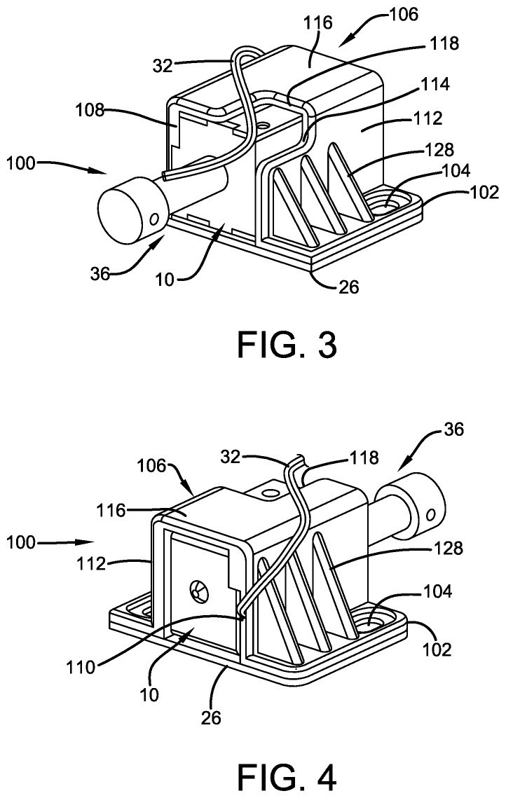

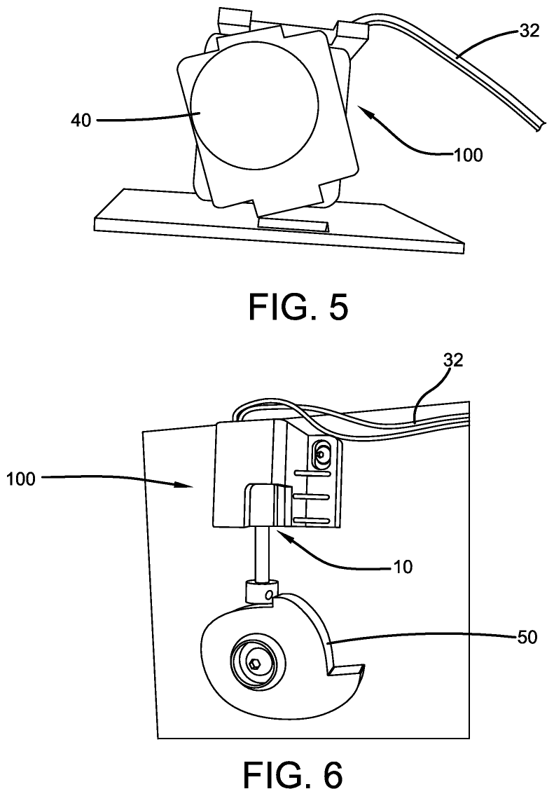

Returning to FIG. 1, the bracket mount device 100 comprises a pair of base flanges 102 and a solenoid case bracket 106. The solenoid case bracket 106 of the bracket mount device 100 partially encapsulates the solenoid 10 as illustrated in FIGS. 3-5. Each of the pair of base flanges 102 comprises a securing hole 104. Each securing hole 104 is located so as to align with securing holes in the solenoid 10 so that the solenoid mounting screws are used to secure the bracket mount device 100 over the solenoid 10.

The solenoid case bracket 106 comprises a first sidewall 108, a second sidewall 112, and a top 116. The first sidewall 108 extends substantially perpendicularly upward out of and from one of the pair of base flanges 102. The second sidewall 112 extends substantially perpendicularly upward out of and from the other base flange 102. The first sidewall 108 and the second sidewall 112 are connected by the top 116 to form the solenoid case bracket 106. The solenoid case bracket 106 is open along the bottom to accommodate the mounting plate 26, and open in the front and the back.

The first sidewall 108 comprises an inside surface 109 and a channel 110. The channel 110 is formed into the inside surface 109 and configured to create a path for the electrical leads 32 of the solenoid 10 as illustrated in FIGS. 3 and 4. The second sidewall 112 comprises a sidewall cutaway portion 114. The sidewall cutaway portion 114 is a substantially rectangular shaped notch cut into the second sidewall 112 in the top/front corner where the second sidewall 112 would otherwise meet the top 116. The top 116 comprises a top cutaway portion 118. The top cutaway portion 118 is a substantially rectangular shaped notch cut into the top 116 in the front corner where the top 116 would otherwise meet the second sidewall 112. This leaves an open corner removed from the solenoid case bracket 106 in the front where the second sidewall 112 would otherwise meet the top 116. The top 116 may further comprise a hole 120 as illustrated in FIG. 1.

The bracket mount device 100 further comprises a plurality of stabilizing elements 128. The plurality of stabilizing elements 128 may be configured as fins, ribs, trusses, or the like. The plurality of stabilizing elements 128 are designed to reinforce the bracket mount device 100. The plurality of stabilizing elements 128 reinforce the connection between each of the pair of base flanges 102 and the corresponding first and second sidewalls 108 and 112. The entire bracket mount device 100 is integrally formed or cast as a single piece for further stability. As illustrated in FIG. 6, the bracket mount device 100 reinforces the solenoid 10 as the plunger 36 engages a cam 50.

It is contemplated that the bracket mount device 100 is constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

Notwithstanding the forgoing, the bracket mount device 100 of the present invention and its various structural components can be of any suitable size, shape, and configuration as is known in the art without affecting the overall concept of the invention, provided that it accomplishes the above stated objectives. One of ordinary skill in the art will appreciate that the shape and size of the bracket mount device 100 and its various components and material, as shown in the FIGS. are for illustrative purposes only, and that many other shapes and sizes of the bracket mount device 100 are well within the scope of the present disclosure. Although the dimensions of the bracket mount device 100 are important design parameters for attaining maximum sterile environment, the bracket mount device 100 and its components may be of any shape or size that ensures optimal performance during use and/or that suits user need and/or preference.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bracket mount device for protecting a solenoid, the bracket mount device comprising:
a pair of base flanges; and
a solenoid case bracket comprising:
a first sidewall extending perpendicularly from one of the base flanges;
a second sidewall extending perpendicularly from the other base flange; and
a top connecting the first and second sidewalls.

2. The bracket mount device of claim 1, wherein each base flange comprises a securing hole.

3. The bracket mount device of claim 1, wherein the first sidewall comprises a channel formed into an inside surface of the first sidewall.

4. The bracket mount device of claim 1, wherein the second sidewall comprises a cutaway portion where the second sidewall joins the top.

5. The bracket mount device of claim 1, wherein the top comprises a top cutaway portion where the top joins the second sidewall.

6. The bracket mount device of claim 1, wherein the top comprises an opening.

7. The bracket mount device of claim 1 further comprising a plurality of stabilizing elements reinforcing the bracket mounting device.

8. The bracket mount device of claim 1, wherein the solenoid is a linear plunger solenoid.

9. A bracket mount device for protecting a solenoid, the bracket mount device comprising:
a pair of base flanges; and
a solenoid case bracket comprising:
a first sidewall extending perpendicularly from one of the base flanges;
a second sidewall extending perpendicularly from the other base flange; and
a top connecting the first and second sidewalls; and
wherein the bracket mount device is integrally formed as a single piece.

10. The bracket mount device of claim 9 further comprising a plurality of stabilizing elements reinforcing the bracket mounting device.

11. The bracket mount device of claim 10, wherein the plurality of stabilizing elements are fins.

12. The bracket mount device of claim 9, wherein each base flange comprises a securing hole.

13. The bracket mount device of claim 9, wherein the first sidewall comprises a channel formed into an inside surface of the first sidewall.

14. The bracket mount device of claim 9, wherein the second sidewall comprises a cutaway portion where the second sidewall joins the top.

15. The bracket mount device of claim 9, wherein the top comprises a top cutaway portion where the top joins the second sidewall.

16. A bracket mount device for partially encapsulating a linear plunger solenoid, the bracket mount device comprising:
a pair of base flanges;
a solenoid case bracket comprising:
a first sidewall extending perpendicularly from one of the base flanges;
a second sidewall extending perpendicularly from the other base flange;
a top connecting the first and second sidewalls; and
a plurality of stabilizing elements reinforcing a connection between the pair of base flanges and the first and second sidewalls; and
wherein the bracket mount device is integrally formed as a single piece.

17. The bracket mount device of claim 16, wherein the first sidewall comprises a channel formed into an inside surface of the first sidewall.

18. The bracket mount device of claim 16, wherein the second sidewall comprises a cutaway portion where the second sidewall joins the top.

19. The bracket mount device of claim 16, wherein the top comprises a top cutaway portion where the top joins the second sidewall.

20. The bracket mount device of claim 16, wherein the plurality of stabilizing elements are ribs.
